(19) United States
(12) Patent Application Publication
(10) Pub. No.: US 2015/0024342 A1
(43) Pub. Date: Jan. 22, 2015

(54) Endodontic Instrument With Narrow Radial Lands

(71) Applicant: ANDRIS JAUNBERZINS, BROOKFIELD, WI (US)

(72) Inventor: ANDRIS JAUNBERZINS, BROOKFIELD, WI (US)

(21) Appl. No.: 13/945,696

(22) Filed: Jul. 18, 2013

(51) Int. Cl. A61C 5/02

(52) U.S. Cl. CPC A61C 5/023
USPC 433/102

(57) ABSTRACT

An improved endodontic instrument has a uniform tapered working length with at least two helical shaped flutes and spiraled lands having a land width no greater than 0.101 mm as measured in a plane perpendicular the central axis of rotation of instrument. The land width is preferably constant along the working length but may vary provided it does not exceed 0.101 mm. The instrument resists mid-root transportation and exhibits superior fatigue performance and cutting efficiency compared to prior art instruments.

### BACKGROUND OF THE INVENTION

1. Field of the Invention

This invention relates generally to the field of dentistry and more particularly to endodontic files or reamers used in the cleaning of material present in the root canal of human teeth and for enlarging and shaping the root canal so that it is prepared for receiving filling material.

2. Description of the Related Art

Instruments that enable an endodontist to clear and clean the root canal of a tooth are well-known in the art. Because of the geometry of a root canal, these instruments—typically referred to as endodontic files—experience significant flexing and twisting while in use, making them susceptible to breakage. Because of the breakage problem and the danger that it poses to a patient, nickel-titanium alloy (NiTi or Nitinol™) generally is viewed as a better material for use in manufacturing these instruments than is stainless steel. Relative to stainless steel, NiTi is able to withstand a far greater amount of twisting or bending without experiencing permanent deformation or breaking.

The design challenge is multi-dimensional: to provide a NiTi instrument that is flexible, resists torsional breakage and cyclic fatigue, cuts efficiently, and does not transport the root canal during cutting. Unfortunately, these design objectives run counter to one another. Therefore, prior art instrument designs represent the various tradeoffs made among these objectives. To date, all the prior art instrument designs teach away from providing narrow radial land widths along the entire working length of a straight or uniform taper instrument.

The prior art has assumed that radial lands in the range of at least 0.004 to 0.006 inches (about 0.102 to 0.152 mm) are required to get optimum cutting yet prevent mid-root transportation when a standard K-file or reamer is employed in a curved root canal. See e.g., U.S. Pat. No. 4,934,934 to Arpaio, Jr. et al.; Re. 34,439 (reissue of 4,871,312) and U.S. Pat. No. 5,762,497 to Heath; and U.S. Pat. No. 5,941,760 to Heath et al. To achieve this performance, the land width selected in this range should be held constant along the working length of the instrument.

Where lands having a width below 0.004 inches (about 0.102 mm) are disclosed, the instrument shape is altered from a uniform or straight taper shape and the narrow lands are only located at the tip and shank portions of the instrument. For example, U.S. Pat. App. Pub. No. 2007/0026360 to Buchanan discloses a land width below that of Arpaio, Jr. and Heath, in the range of 0 to 0.004 inches, except for lands located along an under-contoured (narrower) intermediate or middle waist portion of the working length. The lands in the waist portion are relatively wide—for example, in the range of 0.004 to 0.006 inches—compared to those in the tip and shank portions. Buchanan claims that the combination of multiple contours or heights and multiple land width variations along the working length reduces taper lock, increases cutting efficiency, and minimizes or eliminates transportation. See Buchanan at para. 0030 (noting “the wider land in the mid-region of the instrument prevents or minimizes straightening of curved canals at their mid-points.”) Similar to Arpaio, Jr. and Heath, Buchanan also discloses that a wide land width prevents transportation of the root canal path but increases the likelihood of breakage due to cyclic fatigue because of reduced cutting efficiency (therefore requiring more revolutions to accomplish a certain shaping objective). On the other hand, a narrow land width reduces the likelihood of breakage because of increased cutting efficiency but increases the chances of mid-root transportation.

Buchanan also found that a straight taper instrument having narrow land widths toward the shank end of the instrument and relatively wider land widths toward the tip end increases mid-root transportation to unacceptable levels. See Buchanan at para. 0006. This transportation is most likely the result of stiffness created by the increasing land widths in the waist portion of the instrument. Additionally, as the width of the radial land increases, torque strength increases but so does drag.

Subsequent testing by the Applicant has discovered that a straight taper instrument having narrow land widths in the shank and tip portions but wider lands in the waist portion does lead to stiffness, which is evidenced by stress concentrations in the waist portion as the instrument traverses a curved portion of a root canal. The Applicant also has conducted experimentation with instruments having a wider waist portion relative to the shank and tip end portions and narrow lands along the length of the instrument. These instruments also experienced unacceptable mid-root transportation. The Applicant then decided to manufacture a straight taper K-file having narrow radial lands along its entire length. Unexpectedly and surprisingly, the instrument exhibited no mid-root transportation in addition to superior cutting performance and resistance to cyclic fatigue. Preferred embodiments of this file is disclosed herein.

### SUMMARY OF THE INVENTION

An improved endodontic instrument made according to this invention has a uniform tapered working length that includes spiraled lands having a land width no greater than 0.101 mm as measured in a plane perpendicular the central axis of rotation of the instrument. The land width may vary along the working length provided that it does not exceed 0.101 mm. The taper is preferably in the range of 0.02 to 0.08 mm per mm, with the instrument size being in the range of 8 to 70.

An object of this invention is to provide an improved endodontic instrument that provides superior cutting performance and resistance to cyclic fatigue. Another object of this invention is to provide an endodontic instrument that does not transport the root canal as the instrument navigates and shapes a curved portion of the canal.

### BRIEF DESCRIPTION OF THE DRAWINGS

FIG. 1 is a view of a preferred embodiment of an endodontic instrument according to this invention. The instrument has a uniform taper, at least two helical flutes, and narrow radial lands located between the helical flutes along the entire working length of the instrument.

FIG. 2 is a view taken along section line 2-2 of FIG. 1 illustrating a preferred embodiment of the endodontic instrument. The instrument has four substantially straight helical flute surfaces with narrow radial lands located between each adjacent pair of flutes.

FIG. 3 is a view taken along section line 3-3 of FIG. 1 illustrating another preferred embodiment of the endodontic instrument. The instrument has four concave-shaped helical flutes with narrow radial lands located between each adjacent pair of flutes.

FIG. 4 is a view taken along section line 4-4 of FIG. 1 illustrating yet another preferred embodiment of the endodontic instrument. The instrument has three substantially straight helical flute surfaces with narrow radial lands located between each adjacent pair of flutes.

FIG. 5 is a view taken along section line 5-5 of FIG. 1 illustrating yet another preferred embodiment of the endodontic instrument having three concave-shaped helical flutes defined by a radius of curvature and forming narrow radial lands between each adjacent flute.

FIG. 6 is a view taken along section line 6-6 of FIG. 1 illustrating another preferred embodiment of the endodontic instrument. The instrument has three convex-shaped helical flutes with narrow radial lands located between each adjacent pair of flutes.

FIG. 7 is a graphical depiction of a prior art endodontic instrument having wide lands in the mid-portion of the working length—or alternatively narrow lands in a wider mid-portion of the working length—as the working length of the instrument would appear when traversing a curved root canal.

FIG. 8 is a graphical depiction of the endodontic instrument of FIG. 1 as its working length would appear when traversing a curved root canal.

FIG. 9 is an enlarged view of the curved and stressed mid-portion of the working length of the prior art endodontic instrument of FIG. 7. Because of the wide lands (or the wider waist portion) the mid-portion experiences severe and moderate stress concentrations which make it prone to cyclic fatigue and breakage.

FIG. 10 is a view an enlarged view of the mid-portion of endodontic instrument of FIG. 8. The narrow lands in the mid-portion eliminate the areas of stress concentration which are experienced by the wider landed or wider waist instrument of FIG. 9.

FIG. 11 is a view of the prior art endodontic instrument of FIG. 7 as it traverses a curved root canal and experiences mid-root transportation.

FIG. 12 is a view of the instrument of FIG. 1 as it traverses a curved root canal. The instrument experiences no mid-root transportation.

### DETAILED DESCRIPTION OF THE PREFERRED EMBODIMENTS

Preferred embodiments of an endodontic instrument made according to this invention will now be described in reference to the drawings and the following element numbering:

| | |
|---|---|
| 10 | Endodontic instrument |
| 11 | Flute surfaces |
| 13 | Shank or proximal end |
| 14 | Waist or mid-portion |
| 15 | Tip or distal end |
| 17 | Radial land |
| 19 | Central axis of rotation |
| 20 | Plane perpendicular to 19 |
| 21 | Handle portion |
| 23 | Depth calibration grooves |
| 24 | Working length |
| 25 | Transportation |
| 27 | Area of moderate stress concentration |
| 29 | Area of severe stress concentration |

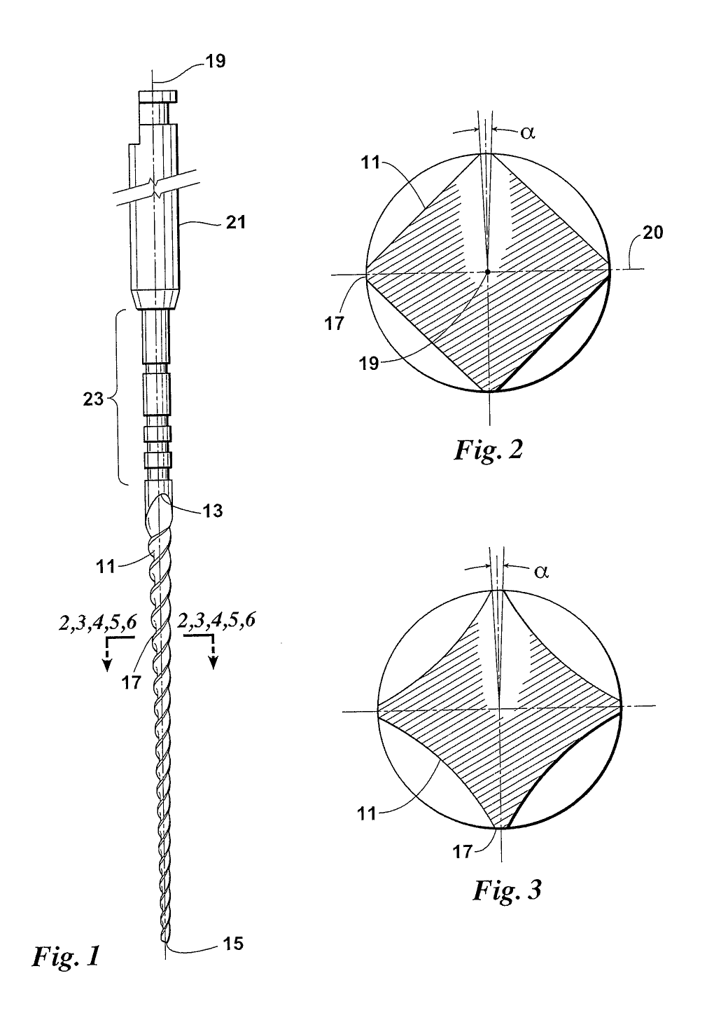

Referring first to FIG. 1, an endodontic instrument 10 includes two or more continuously spiraled flute surfaces 11 extending between the shank end 13 and tip end 15 of the instrument 10. Adjacent flute surfaces 11 form a radial land 17 that provides an edge for cutting or scraping the wall of a root canal in order to shape the canal as the instrument 10 is manually or mechanically manipulated about its central axis of rotation 19. Therefore, the radial lands 17 are located along the active portion or working length 24 that lies between the shank and tip ends 13, 15. Working length 24 is preferably about 16 mm to 25 mm in length and follows a predetermined straight or uniform taper so that the diameter at its tip end 15 is less than the diameter at its the shank end 13. Although not forming a part of this invention, the handle portion 21 of instrument 10 may be configured for manual or mechanical manipulation and includes depth calibration grooves 23.

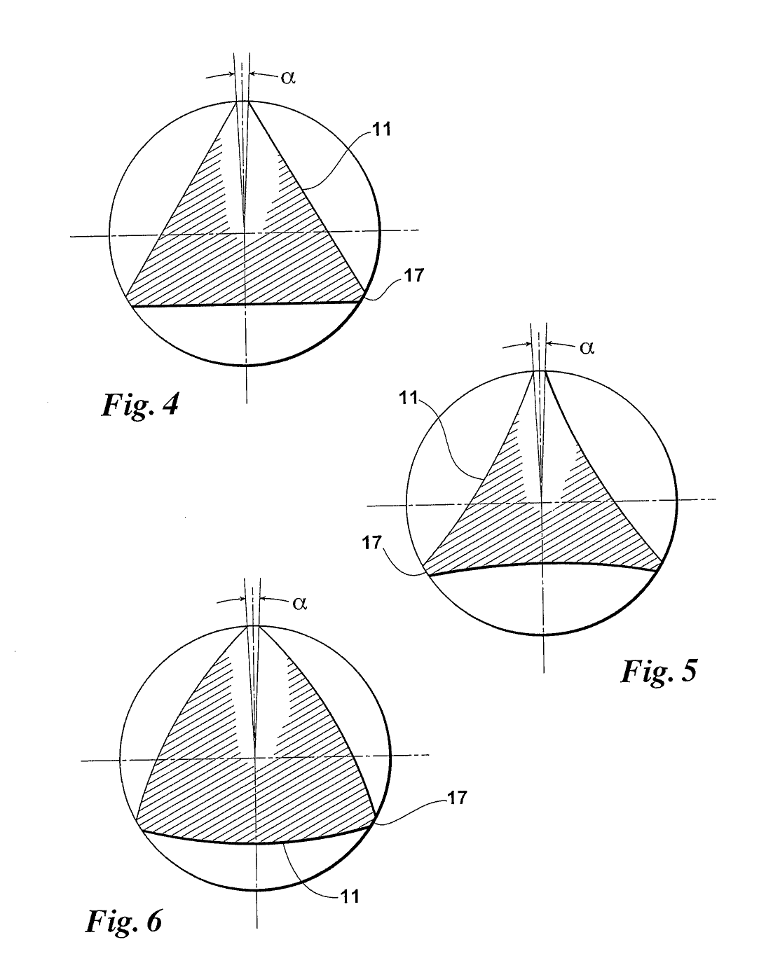

Referring now to FIGS. 2 to 6, the flute surfaces 11 may be straight, convex or concave surfaces that form radial lands 17. The cross-sectional shape of the working length 24 is preferably constant. That is to say, the desired number and shape of flute surfaces 11 do not change from one cross-section to the next along working length 24. Central to this invention is that the radial lands 17 are narrow lands, meaning that their width as measured in a plane 20 lying perpendicular to the central axis of rotation 19 is no greater than about 0.0039 inches (0.101 mm). In one preferred embodiment, the radial lands 17 were so narrow as to appear to form a sharp point.

Measured in terms of degrees of arc α, the maximum degrees of arc α at each diameter Dn for various sizes of instruments having a 0.02 mm per mm taper does not exceed those as listed in Table 1, where n is the distance in millimeters from tip end 15. For example, a size 8 instrument having a 0.02 taper has a D1 diameter of 0.08 mm and a D2 of 0.10. A size 8 instrument having a 0.08 taper has a D1 and D2 diameter of 0.08 and 0.16 mm, respectively. To calculate the maximum degrees of arc “α” at any given cross-section “n” so as to not exceed a predetermined maximum land width “w” at that cross-section “n” for any given size instrument “s” and taper “t”, the following formula may be used:

$$Max {α}_{n} = \frac{360 {w}_{n}}{π [ ( n - 1 ) t + s ]}$$

where “n” is measured from the tip end of the instrument and “s” is the instrument size in hundredths (e.g., size 8 equates to an “s” of 0.08 mm).

It has always been assumed by the designers of endodontic instruments that wider radial lands are needed in the waist portion 14 of the instrument to keep the instrument from transporting the root canal. The waist portion 14 generally begins about 9 to 11 mm from proximal end 13 and ends about 2½ to 3 mm from the tip end 15, respectively (or about 9 to 11 mm from the distal end. However, referring now to FIGS. 7, 9 & 11, digital photography revels that a prior art endodontic instrument having narrower radial lands at the shank and tip portions 13, 15 and wider radial lands at the waist portion 14 still experiences unacceptable levels of mid-root transportation 25 as the instrument navigates about a 45° curvature of a simulated root canal R in a resin block B. Thermal spectroscopy also reveals areas of moderate 27 and severe 29 stress concentration in the waist portion 14 as the prior art instrument traverses the curvature of canal R. These areas of stress concentration 27, 29 negatively affect the cyclic fatigue performance of the instrument. These findings are in line with those of Buchanan, as was discussed in the Background section. However, Buchanan, in keeping with conventional wisdom, tried to solve the problem by keeping the wider lands in the waist portion 14 but altering the contour of the instrument.

TABLE 1
Maximum degrees of arc to achieve an arc length no greater than 0.101 mm at
the D₁ to D₁₆ diameters for various instrument sizes having a 0.02 taper.

| Instrument | Working length diameter Dₙ | | | | | | | | | | | | | | | |
|---|---|---|---|---|---|---|---|---|---|---|---|---|---|---|---|---|
| Size | 1 | 2 | 3 | 4 | 5 | 6 | 7 | 8 | 9 | 10 | 11 | 12 | 13 | 14 | 15 | 16 |
| 8 | 145 | 116 | 96 | 83 | 72 | 64 | 58 | 53 | 48 | 45 | 41 | 39 | 36 | 34 | 32 | 30 |
| 10 | 116 | 96 | 83 | 72 | 64 | 58 | 53 | 48 | 45 | 41 | 39 | 36 | 34 | 32 | 30 | 29 |
| 15 | 77 | 68 | 61 | 55 | 50 | 46 | 43 | 40 | 37 | 35 | 33 | 31 | 30 | 28 | 27 | 26 |
| 20 | 58 | 53 | 48 | 45 | 41 | 39 | 36 | 34 | 32 | 30 | 29 | 28 | 26 | 25 | 24 | 23 |
| 25 | 46 | 43 | 40 | 37 | 35 | 33 | 31 | 30 | 28 | 27 | 26 | 25 | 24 | 23 | 22 | 21 |
| 30 | 39 | 36 | 34 | 32 | 30 | 29 | 28 | 26 | 25 | 24 | 23 | 22 | 21 | 21 | 20 | 19 |
| 35 | 33 | 31 | 30 | 28 | 27 | 26 | 25 | 24 | 23 | 22 | 21 | 20 | 20 | 19 | 18 | 18 |
| 40 | 29 | 28 | 26 | 25 | 24 | 23 | 22 | 21 | 21 | 20 | 19 | 19 | 18 | 18 | 17 | 17 |
| 45 | 26 | 25 | 24 | 23 | 22 | 21 | 20 | 20 | 19 | 18 | 18 | 17 | 17 | 16 | 16 | 15 |
| 50 | 23 | 22 | 21 | 21 | 20 | 19 | 19 | 18 | 18 | 17 | 17 | 16 | 16 | 15 | 15 | 14 |
| 55 | 21 | 20 | 20 | 19 | 18 | 18 | 17 | 17 | 16 | 16 | 15 | 15 | 15 | 14 | 14 | 14 |
| 60 | 19 | 19 | 18 | 18 | 17 | 17 | 16 | 16 | 15 | 15 | 14 | 14 | 14 | 13 | 13 | 13 |
| 70 | 17 | 16 | 16 | 15 | 15 | 14 | 14 | 14 | 13 | 13 | 13 | 13 | 12 | 12 | 12 | 12 |
| 80 | 14 | 14 | 14 | 13 | 13 | 13 | 13 | 12 | 12 | 12 | 12 | 11 | 11 | 11 | 11 | 11 |
| 90 | 13 | 13 | 12 | 12 | 12 | 12 | 11 | 11 | 11 | 11 | 11 | 10 | 10 | 10 | 10 | 10 |
| 100 | 12 | 11 | 11 | 11 | 11 | 11 | 10 | 10 | 10 | 10 | 10 | 9 | 9 | 9 | 9 | 9 |
| 110 | 11 | 10 | 10 | 10 | 10 | 10 | 9 | 9 | 9 | 9 | 9 | 9 | 9 | 9 | 8 | 8 |
| 120 | 10 | 9 | 9 | 9 | 9 | 9 | 9 | 9 | 9 | 8 | 8 | 8 | 8 | 8 | 8 | 8 |
| 130 | 9 | 9 | 9 | 9 | 8 | 8 | 8 | 8 | 8 | 8 | 8 | 8 | 8 | 7 | 7 | 7 |
| 140 | 8 | 8 | 8 | 8 | 8 | 8 | 8 | 8 | 7 | 7 | 7 | 7 | 7 | 7 | 7 | 7 |
| 150 | 8 | 8 | 8 | 7 | 7 | 7 | 7 | 7 | 7 | 7 | 7 | 7 | 7 | 7 | 7 | 6 |

Although Buchanan saw the need for narrow radial lands at the tip and shank end of the instrument, he avoided narrow radial lands in the waist portion 14 because conventional wisdom held that to provide narrow lands in this portion of the instrument would require that the waist portion 14 be widened. However, widening the waist portion 14 leads to similar transportation 25 and stress concentration 27, 29 because a wider waist causes stiffness. Therefore, Buchanan elected to narrow the waist portion but widen the lands relative to the tip and shank portions.

The prior art also teaches that an instrument having a straight or uniform taper but narrow radial lands 17 along its entire working length 14 would experience unacceptable levels of transportation 25 due to, for example, flexing of the waist portion as either the shank or tip ends 13, 15 thread into the root canal R or their cutting or scraping edges drag across the walls of canal R. Buchanan is indicative of the lengths that endodontic designers will go to in order to avoid narrow lands in the waist portion 14 of the instrument. Compared to the current invention, Buchanan's design is complex and more costly to manufacture.

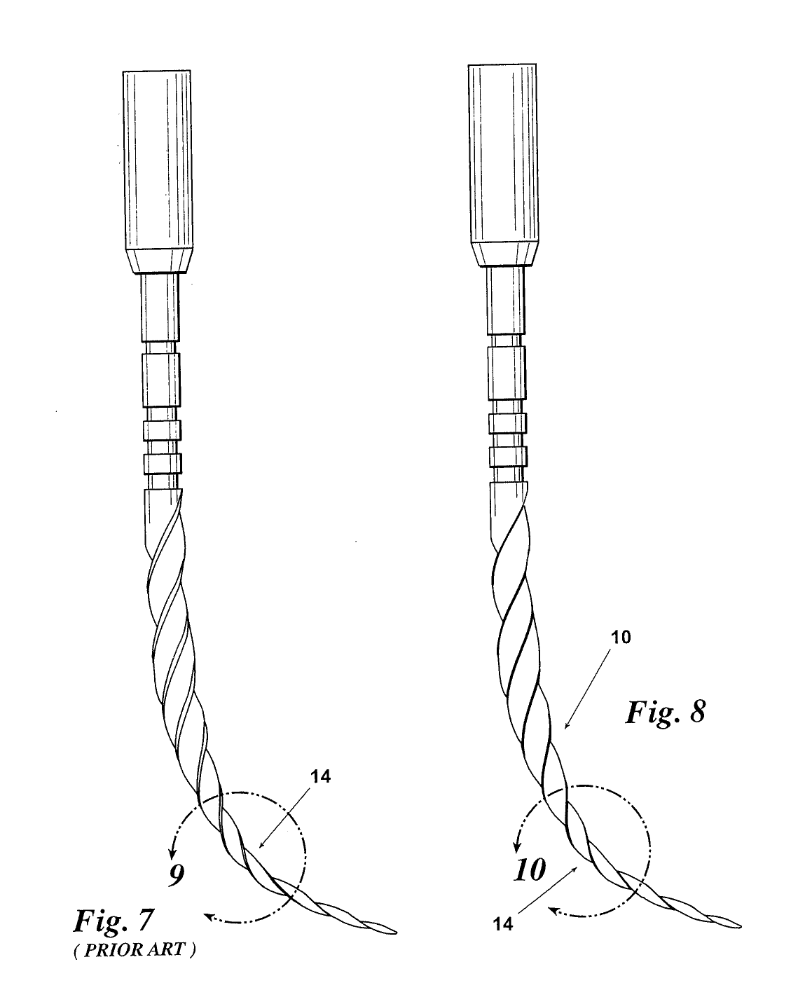

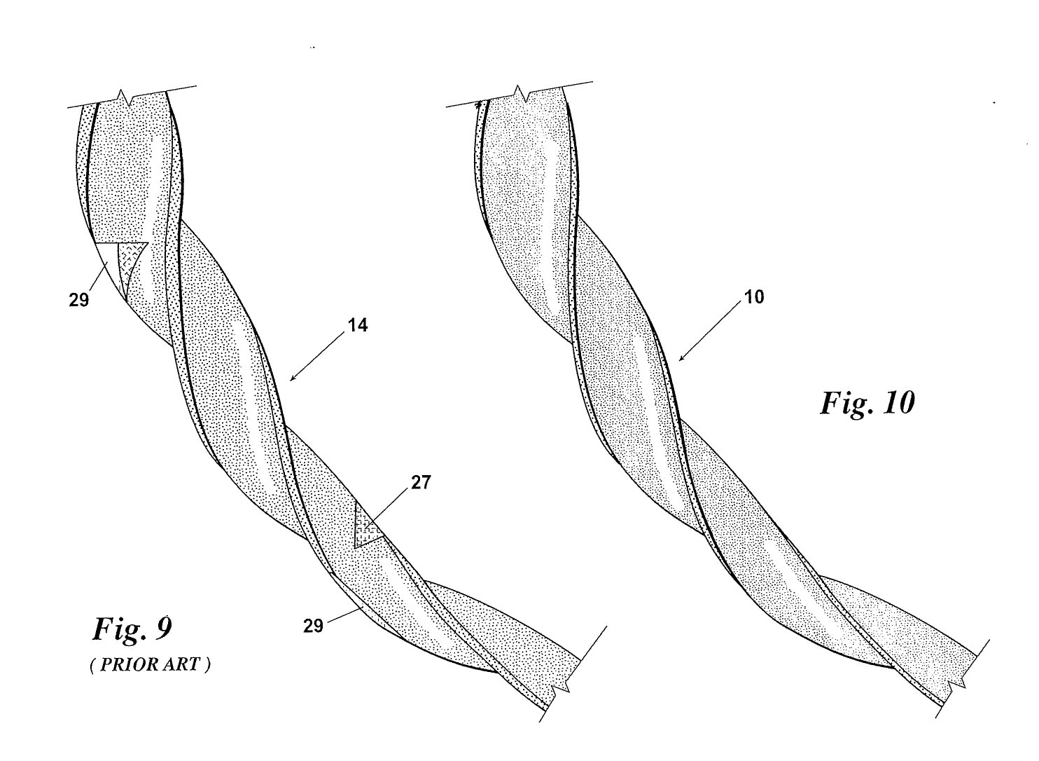

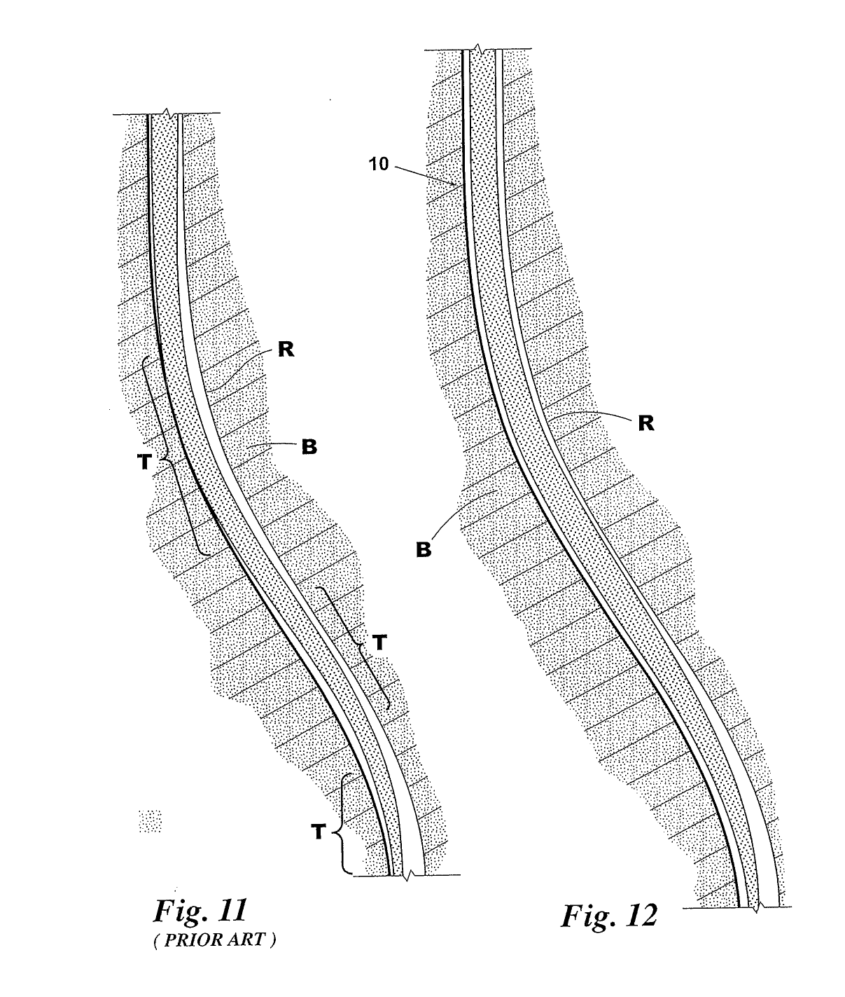

Referring now to FIGS. 8, 10 & 12 a preferred embodiment of an endodontic instrument made according to this invention was tested in a simulated root canal R in a resin block B. Unexpectedly and surprisingly, the instrument 10 exhibited no mid-root transportation in its waist portion 14 as the instrument traversed a 45° curvature. Furthermore, thermal spectroscopy indicated no areas of severe or moderate stress concentrations in the waist portion 14 or along the working length 24.

The fact that improved endodontic instrument 10 experiences no mid-root transportation and has no areas of stress concentration was demonstrated in subsequent testing. Two PROFILE® instruments (DENTSPLY Tulsa Dental Specialties, Tulsa, Okla.) were made according to this invention and compared under the same set of test conditions to other prior art, sharp-cutting non-landed instruments. One of the PROFILE® instruments was made out of M-WIRE™ NiTi wire (DENTSPLY Tulsa Dental Specialties, Tulsa, Okla.) and the other was made out of NiTi wire. The advantage of the M-WIRE is in enhanced resistance to cyclic fatigue. The straight taper of instrument 10 in combination with the narrow radial lands 17 along its working length 24 improved cutting efficiency by a factor of about 1.4.

TABLE 2
Cyclic fatigue and cutting efficiency of various endodontic
instruments having a 0.04 taper and a 25 mm working length.

| | M-WIRE ™ NiTi Wire | | | NiTi Wire | | |
|---|---|---|---|---|---|---|
| | Non-Landed | | Landed | Non-Landed | | Landed |
| | | FLEX- | PROFILE ® | Twisted | | PROFILE ® |
| | K-File | MASTER ® | (land width < | File | K-File | (land width ≈ |
| | (sharp Δ) | (sharp convex Δ) | 0.101 mm) | (sharp Δ) | (sharp Δ) | 0.102 mm) |
| Cyclic Fatigue | 16.16 | 3.45 | 4.73 | 2.88 | 2.00 | 2.31 |
| (min) | | | | | | |
| Efficiency | 2.24 | 1.41 | 1.47 | 1.43 | 1.43 | 1.08 |
| (mm/sec) | | | | | | |

While an endodontic instrument having narrow radial lands along its entire working length has been described with a certain degree of particularity, many changes may be made in the details of construction and the arrangement of components without departing from the spirit and scope of this disclosure. An endodontic instrument according to this disclosure, therefore, is limited only by the scope of the attached claims, including the full range of equivalency to which each element thereof is entitled.

1. An endodontic file comprising:
a longitudinal body having a uniform tapered working length portion extending between a shaft end and a tip end of said longitudinal body and including at least two helical shaped flutes with spiraled lands providing a cutting or scraping edge between said flutes;
said spiraled lands having a land width no greater than 0.101 mm as measured in a plane perpendicular a central axis of rotation of said longitudinal body.

2. An endodontic file according to claim 1 wherein the land width of said spiraled lands is a constant land width between said tip and shaft ends.

3. An endodontic file according to claim 1 wherein the endodontic file is a size 8 (0.08 mm) endodontic file.

4. An endodontic file according to claim 1 wherein the endodontic file is in a range of a size 10 (0.10 mm) to a size 60 (0.60 mm) endodontic file.

5. An endodontic file according to claim 1 wherein the endodontic file is a size 70 (0.70 mm) endodontic file.

6. An endodontic file according to claim 1 further comprising the uniform tapered working length portion tapers in a range of +0.00 to +0.08 mm/mm from said tip end to said shaft end.
